(19) United States
(12) Patent Application Publication
(10) Pub. No.: US 2009/0314750 A1
(43) Pub. Date: Dec. 24, 2009

(54) GAP CONTROL DEVICE AND LASER LAP WELDING METHOD

(75) Inventors: Shigoki Saitoh, Kanagawa (JP); Naoki Ozawa, Shizuoka (JP); Tsutomu Okamoto, Shizuoka (JP)

Correspondence Address: STEIN MCEWEN, LLP, 1400 EYE STREET, NW, SUITE 300, WASHINGTON, DC, 20005, US

(73) Assignee: Suzuki Motor Corproation, Shizuoka (JP)

(21) Appl. No.: 12/489,823

(22) Filed: Jun. 23, 2009

(30) Foreign Application Priority Data
Jun. 24, 2008 (JP) 2008-164375

(51) Int. Cl. B23K 26/20

(52) U.S. Cl. 219/121.64; 219/121.63

(57) ABSTRACT

A gap control device which is configured for use with a laser welding device adapted to weld objects to each other is provided. A laser guide is configured to guide a laser beam to a focusing position. A gap holder is configured to feed the objects in a feeding direction toward the focusing position and to form a predetermined gap between the objects at at least a part of the focusing position. A press is configured to press the object materials at a pressing position which is distant from the focusing position by a predetermined distance in the feeding direction.

This application claims priority from Japanese Patent Application No. 2008-164375 filed Jun. 24, 2008, the entire contents of which are herein incorporated by reference.

### BACKGROUND

The present invention relates to a technical field of laser welding, and more particularly, to a technical field of laser lap welding.

Laser processing is a technique that focuses a laser beam to a very small spot having high-energy density and processes an object. The laser processing includes cutting, boring, welding, heat processing, and the like. The laser welding includes butt welding that makes two objects be butted against each other and performs welding parallel to a butt face, edge welding that performs welding parallel to an edge face of an edge joint, and lap welding that makes objects be lapped and performs welding perpendicularly to a lapped face.

Patent Document 1 discloses a method that removes a gap between objects by pressing the lapped objects with a pressing roller and focuses a laser beam to this pressing position for the purpose of improving weld quality.

Patent Document 2 discloses a method that forms burrs at lapped edges and performs edge welding while forming a gap by the burrs for the purpose of securing weld quality.

Patent Document 3 discloses a method that winds a plate around the outer circumference of an intermediate assembly and then performs laser welding on the entire circumference of the intermediate assembly for the purpose of easily forming a vehicular muffer.

Patent Document 1: Japanese Patent Publication No. 2004-090054 A

Patent Document 2: Japanese Patent Publication No. 2005-052868 A

Patent Document 3: Japanese Patent Publication No. 2003-138935 A

Weld quality is related to a keyhole that is formed at an object. In particular, the weld quality of the penetration welding, where a keyhole is formed from a front surface of the object to a rear surface of the object, is affected by a front surface bead width, a penetration depth, a rear surface bead width, a ratio between the surface bead width and the penetration depth (aspect ratio), effect of inert gas, and the behavior of impurities on the surface or the plating of the object.

In Patent Document 1, the lap welding is performed at the pressing position to remove a gap is removed in order to stabilize the penetration processing. However, if the objects come in close contact with each other to completely remove the gap, attachments (oil, metal powder, and the like) on the surface of metal are evaporated and expand, which causes welding defects such as pinholes. That is, if the gap is completely removed, pinholes (blowhole, porosity, and pit) or sputters (sinks) caused by the influence of impurities are generated. As a result, poor welding, such as decrease of fatigue strength, deterioration of a sealing property, or appearance failure, is caused. For this reason, it is required to form a gap, for example, in the welding of galvanized steel plates so that the poor welding such as poor penetration or underfill does not occur.

In Patent Document 2, not lap welding but edge welding is performed while forming a gap by burrs in order to decrease the poor welding, such as blowholes or sinks. However, this method requires a complex mechanism for forming burrs and cannot be applied to the lap welding. Further, in the edge welding, it is difficult to secure the same strength as the lap-penetration welding.

In Patent Document 3, to manufacture a cylindrical member having a circular or elliptical cross section, a plate is wound around the outer circumference of the intermediate assembly and laser welding is then performed on the entire circumference of the intermediate assembly. Accordingly, it is possible to easily manufacture the cylindrical member. However, if a gap is formed between the plates wound around the outer circumference, it is difficult to stabilize the penetration processing. On the other hand, if a gap is not formed between the plates, failure such as a pinhole is generated.

For example, if an excessively large gap (50% or more of the sheet thickness of 0.7 [mm]) is formed between stainless sheets, only the upper sheet is burned through, so that penetration welding is not achieved and a hole is formed. Accordingly, it becomes necessary to perform a visual check and a leak test for checking a sealing property after the welding. If any problem in sealing property is figured out in these tests, arc welding or the like should be performed in a post-process.

As described above, in the related arts, it is not possible to suppress the generation of a pinhole while stabilizing the penetration processing in the lap welding. That is, it is difficult to simultaneously secure strength and a sealing property of the welding and to secure good yield. Further, it is not possible to easily manufacture a cylindrical member while maintaining the strength and securing a high sealing property as for an object of the lap welding.

### SUMMARY

It is therefore an object of at least one embodiment of the present invention is to provide a gap control device which is configured for use with a laser lap welding device and a laser welding method that simultaneously secure the strength and the sealing property of the laser lap welding and reduce probability of poor welding.

In order to achieve the above-described object, according to an aspect of at least one embodiment of the present invention, there is provided gap control device configured for use with a laser welding device adapted to weld objects to each other, the gap control device comprising: a laser guide, configured to guide a laser beam to a focusing position; a gap holder, configured to feed the objects in a feeding direction toward the focusing position and to form a predetermined gap between the objects at at least a part of the focusing position; and a press, configured to press the object materials at a pressing position which is distant from the focusing position by a predetermined distance in the feeding direction.

According to another aspect of at least one embodiment of the present invention, there is provided laser lap welding method for welding objects to each other, comprising: forming a predetermined gap between the objects at at least a part of a focusing position; injecting shielding gas toward the focusing position; irradiating a laser beam to the focusing position; feeding the objects relative to the focusing position so that the laser beam proceeds in a direction opposite to a feeding direction of the objects; pressing the objects at a pressing position which is distant from the focusing position by a predetermined distance in the feeding direction; and proceeding with the laser beam relative to the objects to the end thereby seam welding the objects to each other.

If the meanings of terms described in each claim are interpreted and the invention according to each claim is recognized with reference to description of this specification and drawings, the invention according to each claim has the following advantages in relation to the related art.

According to at least one embodiment of the present invention, the gap control device guides the laser beams toward the focusing position while forming the predetermined gap at at least a part of the focusing position (laser spots), and presses at the pressing position. Since the gap formed between the objects is adjusted to the predetermined gap at the focusing position and controlled to be decreased toward the pressing position, it is possible to perform melting on the objects while discharging the impurities of the surface or the shielding gas to the outside, thereby suppressing the occurrence of the poor welding. Further, it is possible to achieve the same sealing property as the seam welding by pressing the objects at the pressing position which is distant from the focusing position by the predetermined distance in the feeding direction. By point pressing the objects, it is possible to keep good appearance of a product formed by the objects, and to increase the strength of the product. Furthermore, it is possible to stably manufacture a product having a high sealing property at high yield by performing the laser welding at the focusing position in which the predetermined gap is formed between the object and pressing at the pressing position.

### BRIEF DESCRIPTION OF THE DRAWINGS

The above and other aspects of the present invention will become more apparent by describing in detail exemplary embodiments thereof with reference to the accompanying drawings, wherein:

FIGS. 1(A), 1(B), and 1(C) are schematic views illustrating structural examples according to a first embodiment of the present invention;

FIGS. 2(A), 2(B), and 2(C) are photographs showing results of welding experiments according to the first embodiment;

FIG. 3 is a side view illustrating a gap control device according to the first embodiment;

FIG. 4 is a cross sectional view taken along a line A-A of FIG. 3;

FIGS. 5(A), 5(B), 5(C), and 5(D) are schematic views illustrating processes in lap welding according to the first embodiment;

FIG. 6 is a perspective view illustrating the gap control device according to the first embodiment;

FIG. 7(A) is a perspective view illustrating a seam welding pressure unit according to the first embodiment;

FIG. 7(B) is a perspective view illustrating a spot welding pressure unit according to the first embodiment;

FIG. 8 is a partial front view illustrating the gap control device according to the first embodiment;

FIG. 9(A) is a photograph showing an example of a non-defective product, and FIG. 9(B) is a photograph showing an example of poor welding where a gap exists according to the first embodiment;

FIG. 10 is a schematic view illustrating a gap control device configured for use with a container according to the first embodiment;

FIG. 11 is a schematic view illustrating the gap control device configured for use with the container according to the first embodiment;

FIG. 12 is a schematic view illustrating a process in lap welding applied to a flange of a fuel tank according to the first embodiment; and

FIG. 13 is a flowchart illustrating processes in laser welding according to a second embodiment of the present invention.

### DETAILED DESCRIPTION OF EXEMPLARY EMBODIMENTS

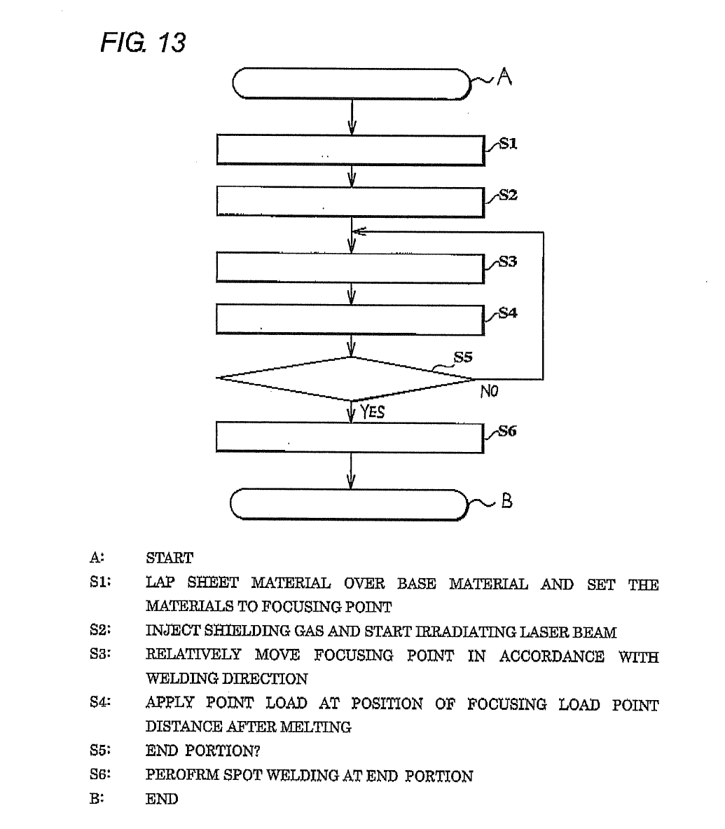

Hereinafter, exemplary embodiments of the invention will be described with reference to the accompanying drawings. A first embodiment corresponds to a gap control device 100 configured for use with a laser lap welding device, and a second embodiment corresponds to a laser welding method illustrated in FIG. 13

### First Embodiment

### 1. Pressure Lap Welding

1.1 Welding Gap t and Focusing Load Point Distance x

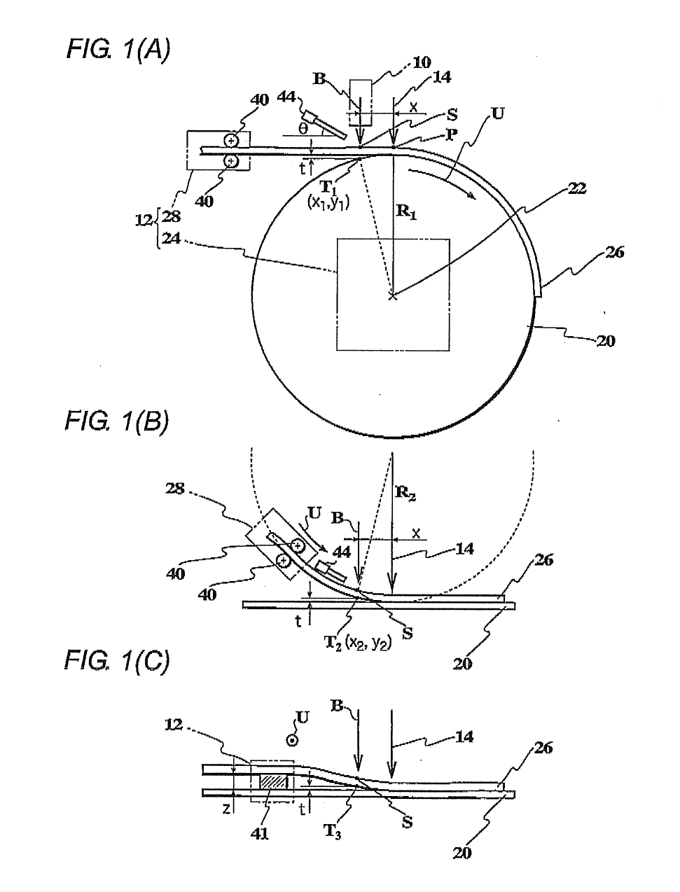

Referring to FIG. 1(A), a gap control device 100 according to the first embodiment includes a laser mechanism 10 that guides laser beams B to focusing position S, a gap holding unit 12 that feeds objects in a feeding direction U toward the focusing position S and forms a predetermined welding gap t between the objects at a part of or all of the focusing position S, and a pressure unit 14 that laps one of the objects over another of the objects and presses the objects at a load point P. The load point P is distant from the focusing position S by a focusing load point distance x in the feeding direction of the objects.

The laser mechanism 10 focuses coherent light generated by a laser oscillator, by an optical system, and irradiates the laser beams B to the focusing position S. A solid laser such as a YAG laser or a gas laser such as a CO₂ laser may be used as this laser. The optical system may use the reflection of a mirror in the case of the CO₂ laser, and may use an optical fiber in the case of the YAG laser. The laser mechanism 10 includes a robot that controls the position of the laser oscillator or the optical system in two or three dimensions.

The laser beams B are focused on the focusing position S, and apply high energy to the one of the objects. The laser beams B are absorbed in the objects, and melts a part of the objects. The focusing position S corresponds to a laser spot having an area, not a point. By moving the focusing position S relative to the objects after melting the objects, the temperature of the melted portion of the objects falls by the atmosphere, so that the melted portion is solidified. Welding is an operation for integrating two or more members by heat, pressure, or a combination of them so that the members joined to each other have continuity therebetween. In a laser welding, the objects are melted using heat generated by focusing the laser beams B, and then melted part of the objects are solidified so as to have continuity between the objects, thereby fixing the objects to each other.

The objects are two or more metals to be joined to each other. For example, stainless steel may be used as the metal. Herein, the object that is not deformed for the lap welding is referred to as a base material 20, and the object that is deformed for the lap welding is referred to as a sheet material 26 or a folded face 27. In an example shown in FIG. 1(A), the base material 20 is a cylindrical metal, and the sheet material 26 is a metallic sheet to be wound around the base material 20. In an example shown in FIG. 1(B), the base material 20 is a metal that is provided horizontally, and the sheet material 26 is a metal sheet to be lapped over the base material 20. A sheet material support 28 feeds the sheet material 26 in the feeding direction U.

The gap holding unit 12 forms a welding gap t between the base material 20 and the sheet material 26 at a part or all of the focusing position S by supporting the base material 20 and the sheet material 26. That is, the gap t may be formed at all of the laser spots. Also, the gap t may be formed at a part of the laser spots and the objects come in close contact with each other at the other of laser spots. The gap holding unit 12 includes a base material support 24 and a sheet material support 28. The base material support rotates the base material 20 which is one of the objects to be welded about a rotation axis 22 of the base material 20 in the feeding direction U. The sheet material support 28 laps the sheet material 26 which is another one of the object to be welded over the outer circumference of the base material 20.

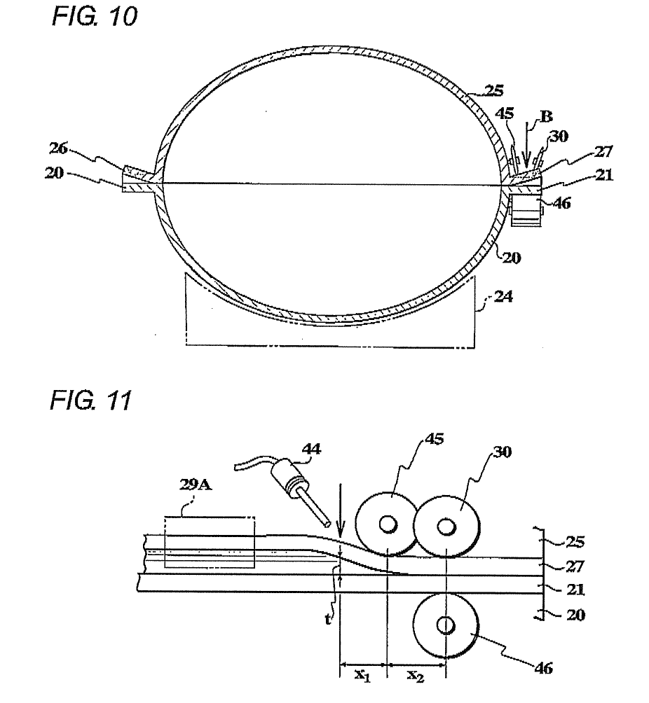

In the examples shown in FIGS. 1(A) and 1(B), the gap holding unit 12 forms a welding gap t by the circumference of a circle that has a rotation axis of the base material 20 or the sheet material 26 as a center. In an example shown in FIG. 1(C), the gap holding unit forms a welding gap t by using a gap gauge. In examples shown in FIGS. 10 and 11, the gap holding unit forms a welding gap t by folding a part of the sheet material 26 in advance.

Referring to FIG. 1(A), the base material support 24 supports the base material 20 so that the base material can be rotated about the rotation axis 22 clockwise (in the feeding direction U). The sheet material support 28 supports and feeds the sheet material, and forms a welding gap t between the base material 20 and the sheet material 26 by a tension roller 40. In the example shown in FIG. 1B, the base material support 24 (not shown) supports the base material 20, and the tension roller 40 feeds the sheet material 26 toward the base material 20 from above to form the welding gap t. In the example shown in FIG. 1(C), the welding gap t is formed by not a tension roller 40 but a gap gauge 41. That is, the gap holding unit 12 includes the gap gauge 41 that is disposed between the base material 20 and the sheet material 26 in front of the focusing position S in the feeding direction U (left side of the focusing position S in FIG. 1(C)) to form a gap between the base material 20 and the sheet material 26. The gap gauge 41, the focusing position S, and the load point P are disposed in this order in the feeding direction U.

The welding gap t is a distance between a point where a contact surface (a rear surface) of the sheet material 26, which is to come in contact with the base material 20 intersects the irradiation direction of the laser beam B, and a point where a surface of the base material 26 intersects the irradiation direction of the laser beam B. The point where the base material 26 intersects the laser beam 13 is referred to as a focusing point denoted by T₁ in FIG. 1(A), by T₂ in FIG. 1(B), and by T₃ in FIG. 1(C).

The focusing position S is a position on the surface of the sheet material 26. A focal position in the irradiation direction of the laser beam B may be determined according to the thickness of the object. The energy caused by the laser beams B penetrates the sheet material 26, passes through the welding gap t, and penetrates the base material 20. In general, inert gas (shielding gas, argon gas, or helium gas), or side gas is injected to the focusing position S in the laser welding. In the example shown in FIG. 1(A), a gas nozzle 44 injects shielding gas, and shields the irradiation position of the laser beam B from the atmosphere. The shielding gas is injected at a shielding gas angle θ. The shielding gas angle θ is an angle that is formed between the injection direction of the shielding gas and a straight line perpendicular to the irradiation direction of the laser beam B. Preferably, the shielding gas angle is in the range of 15° to 30°. Side gas for blowing away generated plasma may be injected to the focusing position S, and the shielding gas shown in FIG. 1(A) and FIG. 1(B) also functions as the side gas in terms of the injection angle θ thereof.

In this embodiment, it is possible to discharge the shielding gas, which exists between the objects, to the outside by irradiating the laser beam B to the position where the welding gap t exists, and to prevent the deterioration of the weld quality that is caused by the shielding gas existing between the base material 20 and the sheet material 26. In a case where the base material 20 and/or the sheet material 26 are galvanized, the deterioration of the weld quality may be caused by the evaporation of the plating. However, in this embodiment, it is possible to suppress the deterioration of the weld quality that is caused by the influence of the impurities such as particles of the plating because the laser welding is performed at the position where the welding gap t exists.

The pressure unit 14 presses the base material 20 and the sheet material 26 at the load point P. The load point P is distant from the focusing position S by a predetermined distance in the feeding direction U (in a direction opposite to the welding direction). The load point P is defined on a plane where the sheet material 26 and the base material 20 substantially overlap each other during the welding. Preferably, the load point P is positioned on a straight line parallel to a weld line and not on the weld line or a weld bead 18. That is, the load point P is positioned along the weld bead 18 at a position that does not overlap a weld bead 18. Further, the pressing may be performed at a point by a roller or the like. A distance between the focusing position S and the load point P in the feeding direction U is referred to as the focusing load point distance x. The focusing load point distance x is exactly a distance between the focusing position S and an intersection of a straight line which is perpendicular to the welding direction and passes through the load point P and a straight line parallel to the weld line on the weld bead 18. In other words, the focusing load point distance x is a distance between the focusing position S and the load point P in the feeding direction U. As the weld bead 18 and a keyhole 16 proceed in a direction opposite to the welding direction (in the feeding direction U in FIGS. 1(A) and 1(B)), the welding gap t at the focusing position S is decreased and becomes 0 at the load point P. By sequentially decreasing the welding gap t to zero while forming the keyhole 16, it is possible to discharge the shielding gas or impurities of the plating to the atmosphere and to achieve high-quality welding.

In a space where the gap control device according to this embodiment is installed, the load point P and the position of a pressure roller 30 may be fixed and the position of the laser mechanism 10 emitting a laser beam B may be variable. In this case, the focusing load point distance x can be variable by fixing the load point P and moving the position of the laser mechanism 10. For example, in the examples shown in FIG. 1(A) and FIG. 1(B), it is possible to adjust the focusing load point distance x by driving the laser mechanism 10 so that the position of the laser beam B is moved horizontally in FIG. 1(A) and FIG. 1(B). Further, it is possible to adjust the welding gap t by adjusting a position of the gap holding unit 12.

The focusing load point distance x may be preliminarily set according to a feeding speed of the objects (the sheet material 26 and the base material 28 in FIG. 1(A)). In the example shown in FIG. 10, the feeding speed can be defined as a relative speed between the focusing position S and the objects (the folded face 27 and a base material face).

For example, in an example where two sheet materials having a thickness of 0.7 [mm] are welded to the base material 20 having a thickness of 1.5 [mm] with a CO₂ laser output of 3 [kW], the feeding speed is set in the range of 1 to 6 [m/min], the focusing load point distance x is set in the range of 3 to 7 [mm], and the welding gap t is set in the range of 0.05 to 0.3 [mm]. It is preferable that the feeding speed is set in the range of about 2 to 3 [m/min], the focusing load point distance x is set within 5 [mm], and the welding gap t is set within 0.3 [mm]. Generally, to increase the welding speed (the feeding speed), it is required to increase a laser output. It also depends on the wavelength or characteristics of the laser.

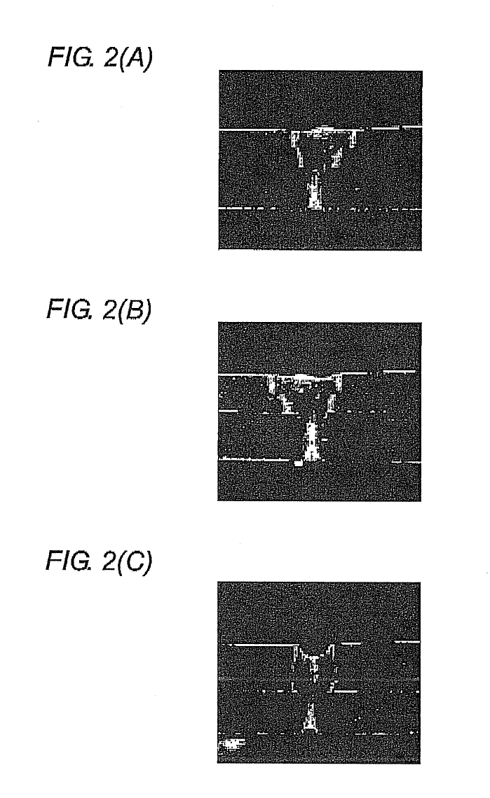

In addition, in the example where a gap gauge 41 is inserted between the base material 20 and the sheet material 26 as shown in FIG. 1(C), when the gauge gap z is set to 0.5 [mm], the objects are fed in a normal direction of the FIG. 1(C) at the welding speed (the feeding speed) of 3 [m/min], the focusing load point distance x is set to 3 [mm] and a welding gap of the other portion other than the focusing position S is set to about 0 [mm] so that a very small gap is partially formed, it is possible to satisfactorily perform penetration welding. The result of this welding experiment is shown in FIG. 2A). In addition, when the welding gap is set to 0.2 [mm] and the focusing load point distance x is set to 5 [mm], it is possible to satisfactorily perform penetration welding. The result of this welding experiment is shown in FIG. 2(B).

On the other hand, when the welding gap is set to 0.4 [mm] and the focusing load point distance x is set to 7 [mm], it is possible to perform penetration welding but underfill occurs. Furthers when the welding gap is set to 0.4 [mm] in and the focusing load point distance x is set to 10 [mm], penetration welding is not completed. The result of this welding experiment is shown in FIG. 2(C).

According to various experimental results, to perform pressing before solidification, it is preferable that pressing is performed at the load point P after about 0.1 [s] passes the laser beam is irradiated to the focusing position S. That is, the focusing load point distance x may be set so that the objects are fed from the focusing position S to the load point P for about 0.1 [s] to satisfactorily perform the penetration welding.

Further, the focusing load point distance x and the welding gap t may be preliminarily set according to a welding radius R.

In order to sequentially decrease the welding gap to about 0 toward the load point P, the objects may be lapped by feeding one of the objects along a straight line and feeding another of the objects along an arc (a circumference). In this case, the welding radius R can be interpreted as a curvature radius of the arc, and a relationship between the focusing load point distance x and the welding gap t may be preliminarily set in accordance with the curvature radius of the arc. The welding radius D is a radius R1 of the rotating cylindrical base material in the example shown in FIG. 1(A), and is a radius R₂ of a circle lapped over the feeding path of the sheet material 26 in the example shown in FIG. 1(B). When the feeding path is combined with the pressure roller 30, the welding radius R may be a radius R of the pressure roller 30. In the examples shown in FIGS. 10 and 11, as described below, the welding radius R may be the welding radius R of a sphere that comes in contact with the folded face 27.

Further, the welding radius R may correspond to not a perfect circle or sphere but an ellipse, and may be defined by the radius of curvature.

The intersection between the circle of the object and the laser beam B is referred to as the base material focusing position T(x,y). If the absolute values of x and y are represented by using R, the focusing load point distance x and the welding gap t may be defined by the following expressions.

x²+y²=R²

y=R·t

t=R·(R²−x²)⁻²

In the example shown in FIG. 1(A), the base material focusing position T₁(x₁,y₁) is positioned on the circumference of the cylindrical base material 20, and is represented by the following expressions.

x₁²+y₁²=R₁²

y₁=R₁−t

t=R₁−(R₁²−x₁²)⁻²

In the example shown in FIG. 1(B), the base material focusing position T₂(x₂,y₂) is positioned on the lapped surface of the cylindrical sheet material 26, and is represented by the following expressions.

x₂+y₂²=R₂²

y₂=R₂−t

t=R₂−(R₂²−x₂²)⁻²

### *1.1. Effect of Welding Gap t and Focusing Load Point Distance x

It is possible to control the gap between the objects by setting a positional relationship between the load point P and the focusing position S of the laser beam 13 as described above, and to suppress the generation of a pinhole that is caused by the evaporation or injection of the attachments.

That is, if the laser beam B is irradiated while the welding gap t is formed, it is possible to perform melting while the plating of the object, the impurities of the surface, or shielding gas is discharged to the outside. Accordingly, it is possible to suppress the occurrence of poor welding. Further, it is possible to achieve the same sealing property as seam welding by performing pressing at the load point P that corresponds to the focusing load point distance x, to keep good appearance of a product formed of the objects by point pressure, and to increase the strength of the product. Furthermore, it is possible to stably manufacture a product, which has a high sealing property, at high yield by performing pressing at the load point P corresponding to the focusing load point distance x and the welding gap t.

In this embodiment, it is possible to independently secure both strength and weld quality by controlling the welding gap t so that the welding gap is decreased toward the load point P in this way.

### 1.2. Winding Pressure Welding

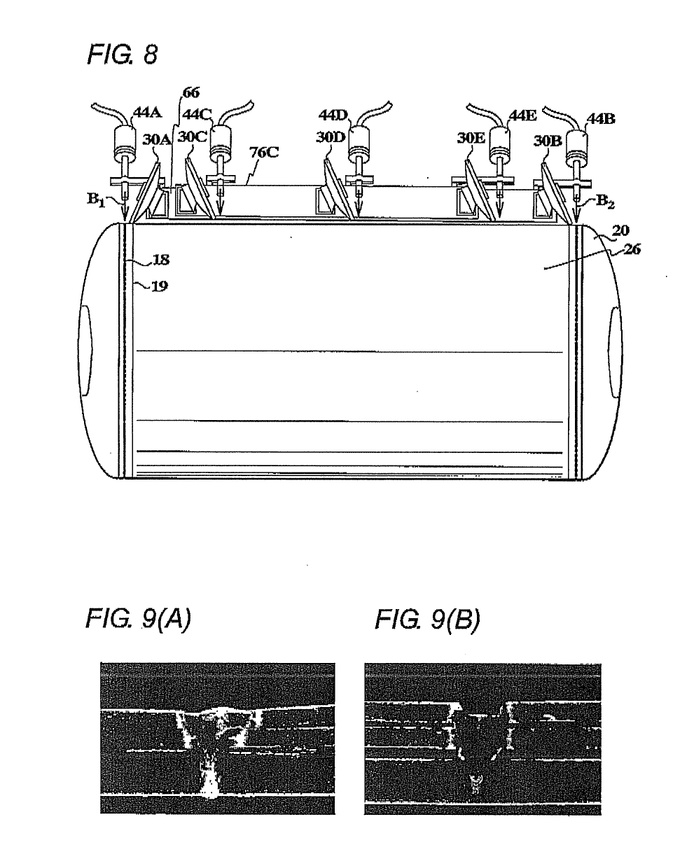

Referring to FIG. 8, the pressure unit 14 includes a pressure roller 30 that is rotated about a rotating shaft body 31 so as to follow the rotation of the base material 20, and a pressure frame 32 that supports the pressure roller 30 so as to allow the pressure roller be rotated and presses the outer circumference of the pressure roller 30 toward the load point P.

The pressure roller 30 comes in contact with the sheet material 26 at a point positioned on the outer circumference of the pressure roller 30, and presses the sheet material 26 and the base material 20 at the load point P. Further, the pressure roller 30 is rotated so as to follow the support of the base material 20 that is performed by the base material support 24, and the rotation of the base material in the feeding direction. The pressure roller 30 may be referred to as a wheel.

The pressure frame 32 includes a pressure roller holding part 34 that holds the pressure roller 30 so as to allow the pressure roller to be rotated, and a pressure roller rotating part 36 that moves the outer circumference of the pressure roller 30 toward the load point P by rotating the pressure roller holding part 34 and the pressure roller 30 as a single body.

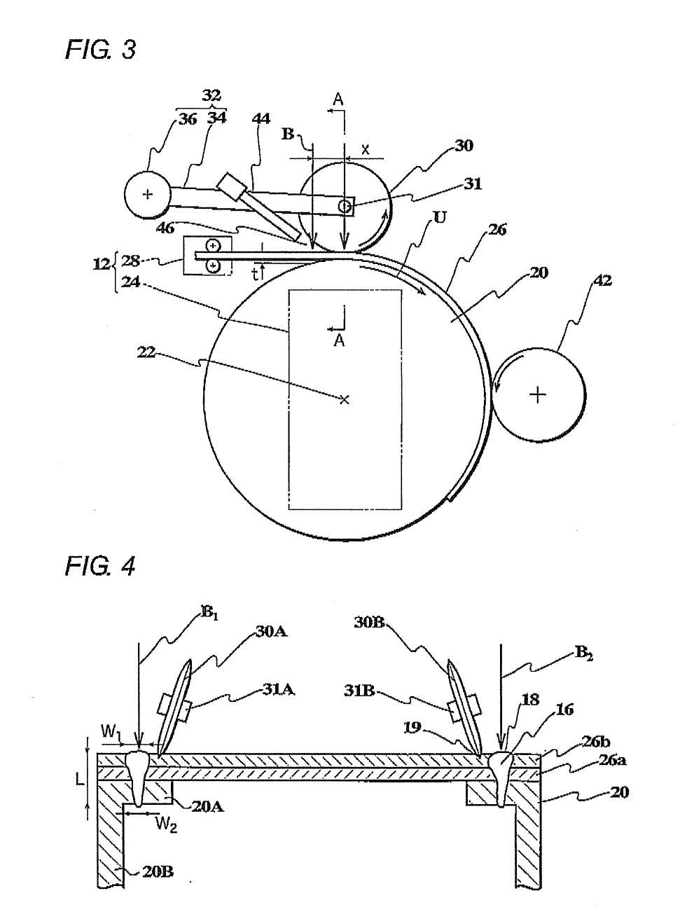

Further, in the example shown in FIG. 3, a looseness preventing roller 42 is provided to prevent the looseness of the welded sheet material 26.

FIG. 4 is a cross-sectional view taken along a line A-A of FIG. 3, and shows a cross-section at the load point P. Referring to FIG. 4, laser welding is simultaneously performed at both ends of the cylindrical member by a pair of laser beams B₁ and B₂. In this embodiment, a pair of (left and right) pressure rollers 30 is disposed to perform welding at both ends of the base material 20. That is, the pressure unit 14 includes a left pressure roller 30A that is rotated about a rotating shaft body 31A, and a right pressure roller 30B that is rotated about a rotating shaft body 31B. As shown in FIG. 4, in order to secure the space that is required for the irradiation of the laser beam 13 and the injection of the shielding gas, the pressure rollers 30A and 30B may be inclined toward the inside of an object to be welded.

As shown in FIG. 4, the base material 20 includes thick portions 20A that are formed at left and right ends and are parallel to the sheet material 26, and disc portions 20B that are formed in a circular shape on the side surfaces of the base material 20. The sheet material 26 is wound around the base material 20 several times. In the example shown in FIG. 4, the sheet material is wound around the base material two times in cross-sectional view.

The laser beams B₁ and B₂ irradiated from the laser mechanism 10 apply high energy density to the object at the focusing position S. Accordingly, high-pressure metal vapor is generated on the irradiated metal surface. In addition, the keyholes 16 are formed in the melted metal. The keyholes 16 absorb the energy of the laser beams B₁ and B₂, and transmit heat to surroundings. Lapped two sheet materials 26 and the thick portions 20A and 20B of the base material 20 are melted by the heat, and the keyholes 16 penetrate the sheet materials to the rear surface of the thick portion. After that, the pair of pressure rollers 30A and 30B presses the objects that are melted at the load point P. The keyholes 16, which are melted portions, are solidified after being pressed at the load point P. In this embodiment, the gap is corrected by performing pressing during a cooling process while impurities or the like are guided to the outside of the keyholes 16 by the welding gap t during the heating as described above. Accordingly, there is no gap during the solidification. Since welding is performed by a rapid heating process using the laser beam B, a gap-correction process, and a rapid cooling process, it is possible to satisfactorily perform welding between materials having high melting points or between different kinds of metals having different heat transfer coefficients.

This embodiment corresponds to lap-penetration welding. In the example shown in FIG. 4, a penetration depth L is a length that is obtained by adding the thickness of the sheet material 26 to the thickness of the thick portion 20A of the base material 20. A ratio (aspect ratio L/W₁) of the penetration depth L to a surface bead width W₁ or a rear surface bead width W2 is related to weld quality, and determines the performance of the laser welding. The keyhole 16 becomes the weld bead 18 and the width of the weld bead 18 is the surface bead width W₁. Further, pressed indents 19 formed by the pressure rollers 30 remain on the surface of the sheet material 26.

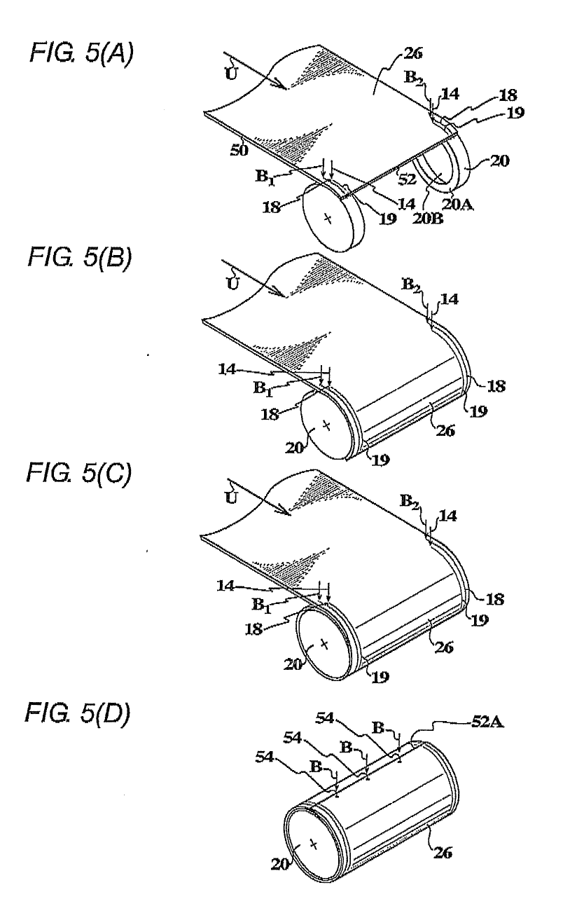

Processes for manufacturing a cylindrical product by laser welding are illustrated in FIGS. 5() to 5(D). As shown in FIGS. 5(A) to 5(D), the cylindrical member is manufactured by winding the sheet material 26 around the base material 20 several times. Meanwhile, a hollow portion of the base material 20 is not shown. As shown in FIG. 5(A), the sheet material 26, which has a length corresponding to multiple times of the circumference of the base material 20 in a direction corresponding to a long side 50 of the sheet, is set to the thick portions 20A of the base material 20. Subsequently, both ends of a short side 52 of the sheet are combined with both ends of the base material 20, so that the sheet material 26 is lapped over the thick portions 20A of the base material 20. Further, the laser beams B₁ and B₂ are irradiated and pressing is performed by the pressure unit 14 such as the pressure roller 30. While the base material 20 is rotated and the sheet material 26 is fed in the feeding direction U (a direction opposite to the welding direction), laser welding is performed. The weld bead 18 is formed by the irradiation of the laser beams B₁ and B₂, and the pressed indents 19 are formed by the pressing.

The base material 20 is rotated and the sheet material 26 is fed as shown in FIG. 5(B), so that laser welding is performed while the sheet material 26 is wound around the base material 20. In a state shown in FIG. 5(C), the sheet material 26 is wound around the base material 20 one time, and the sheet material 26 is further wound around the wound sheet material 26. Welded portions are further melted, pressed, and solidified in the laser welding corresponding to the second or later winding.

After winding is completed several times as shown in FIG. 5(D), spot welding is performed at weld spots 54 of the end 52A of the sheet material 26 corresponding to the short side 52 of the sheet. Since the welding gap t is corrected by the pressure roller 30 and pressing continues to be performed at the load point P in this embodiment, a sealing property is very excellent. Since the sheet material is wound several times, it is possible to easily and stably secure the airtightness of the cylindrical member even though seal welding is not performed at the end 52A of the sheet material 26. Since the end 52A of the sheet material 26 does not interfere with other members when the cylindrical member is mounted, the sheet material may be fixed at the weld spots 54 by easily performing spot welding. For example, even though the spot welding is not performed at the weld spots 54, the cylindrical member manufactured by this embodiment can secure airtightness. Accordingly, gas in the cylindrical member does not leak to the outside even in the case of a water immersion test.

### *1.2. Effect of Winding Welding

As described above, if the laser beams B are focused on a point where the welding gap t is formed, it is possible to perform penetration welding while the shielding gas, the plating on the surface of the object, impurities are released, and to suppress the generation of a pinhole. In addition, if the pressure roller 30 presses the load point P before the welded portions are solidified after the laser beams B are focused, the welding gap t is removed Accordingly, it is possible to stably secure a very high sealing property at high yield.

For example, there is a mechanism that corrects a gap by pressing a portion near a welding point with a finger-like metal plate. However, since a pressing area is wide, a large force is needed to apply pressure enough to correct a gap by partially deforming a plate. Further, winding failure, which is caused by the deformation of a processed product or the decentering of a rotation center, has been generated. In this respect, since a welding gap t is corrected by the pressure roller (wheel) 30 in this embodiment, a gap correcting force may become 4.5 times in the case of the pressure roller 30 as compared to in the pressing using the metal plate even though a gap correcting force (for example, about 100 [kgf]) is constant. Further, since the pressure roller 30 performs pressing while being rotated so as to follow the rotation of the base material 20, it is possible to improve shape accuracy and to keep good appearance.

Winding is performed and spot welding is performed at a plurality of positions. As compared to a method of performing laser welding on the entire circumference thereafter, failure is hardly generated in sealing property. For example, a water immersion test does not need to be performed, and a non-contact test using waves (light, sound, or the like) may be employed. Meanwhile, according to the method in the related art, if failure is generated in sealing property, leaky positions are identified in a post-process, arc welding is performed, and a sealing property needs to be tested. According to this embodiment, it is possible to manufacture a products which has a sealing property over a predetermined level, at very high yield, and to improve a manufacturing process at low cost.

In addition, since weld quality is improved as compared to a method of performing laser welding on the entire circumference after winding, the number of winding may be reduced. Accordingly, it is possible to reduce the weight and manufacturing cost of a product.

### 1.3. Details of Gap Control Device

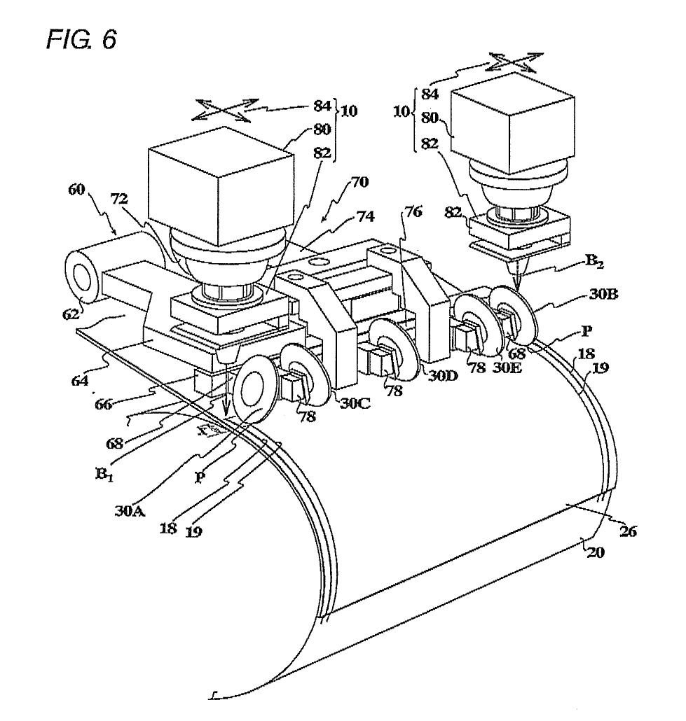

An example of a gap control device, which is used to manufacture a silencer of a muffler by laser welding, will be described below with reference to FIGS. 6 to 9(B).

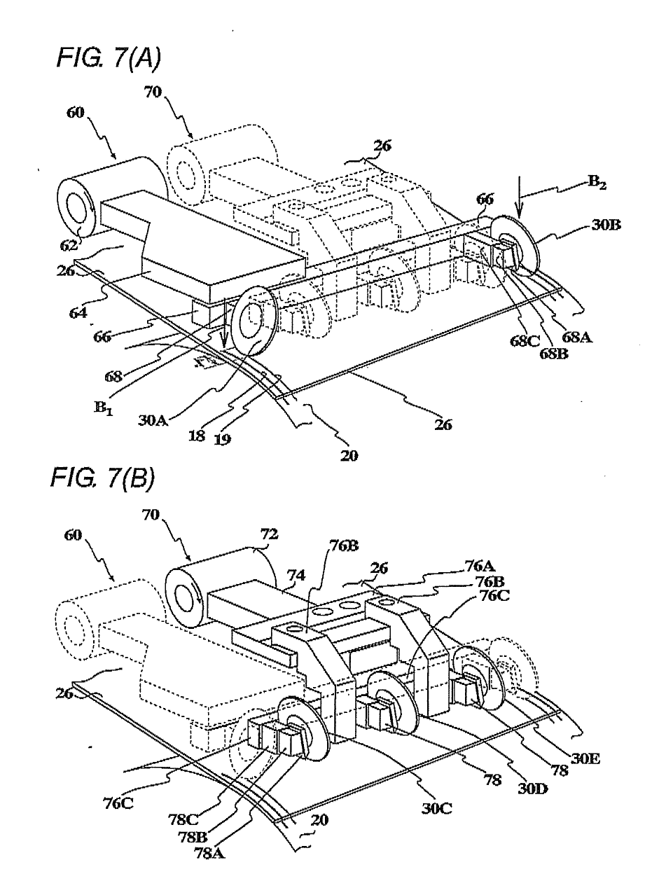

Referring to FIG. 6, a gap control device includes two laser mechanisms 10 that correspond to both ends of a silencer, a seam welding pressure unit 60 (see FIG. 7(A)) that performs pressing at a load point P during the laser welding of the both ends, and a spot welding pressure unit 70 (see FIG. 7(B)) that performs pressing when spot welding is performed at the end 52A of the sheet material 26.

The laser mechanisms 10 includes welding torches 80 that irradiate laser beams B₁ and B₂, air curtains 82 that prevent sputter from being attached during welding, and torch driving parts 84 that control focusing position S by driving the welding torches 80 in X- and Y-axis directions on a plane of which a perpendicular line is parallel to the irradiation direction of the laser beam B. A pair of laser mechanisms 10 simultaneously irradiates laser beams B₁ and B₂ when performing seam welding at both ends of the silencer. Accordingly, weld beads 18 are generated. If the winding welding of the sheet material 26 is completed, the laser mechanisms are driven from the end 52A of the sheet material 26 to the positions of the weld spots 54 and perform spot welding at three positions in the example shown in FIG. 6 (and FIGS. 5(A) to 5(D)).

As shown in FIGS. 6 and 7(A), the seam welding pressure unit 60 includes a seam pressure rotating body 62, a seam pressure frame 64, a seam pressure roller holding part 66, and a seam pressure roller support 68. The seam welding pressure unit 60 presses the pressure rollers 30A and 30B against the sheet material 26 at the load point P, which is distant from the focusing position S by the focusing load point distance x, by rotating the seam pressure rotating body 62. Accordingly, the pressed indents 19 are formed.

Likewise, as shown in FIGS. 6 and 7(B), the spot welding pressure unit 70 also includes a spot pressure rotating body 72, a spot pressure frame 74, a spot pressure roller holding part 76, and a spot pressure roller support 78. The spot welding pressure unit 70 presses pressure rollers 30C, 30D, and 30E against the sheet material 26 by rotating the spot pressure roller holding part 76. The gap of the end 52A of the sheet material 26 is adjusted by the pressing.

Referring to FIG. 7(A), the seam pressure roller support 68 includes a rotating shaft member 68A that holds a rotating shaft of the pressure roller 30B and supports the pressure roller, an inclination member 68B that supports the rotating shaft member 68A by an angle corresponding to an inclination angle of the pressure roller 30B, and a connection member 68C that connects the inclination member 68B to the seam pressure roller holding part 66.

An end of the seam pressure frame 64 is connected to an outer circumferential surface of the seam pressure rotating body 62, and a lower surface of the other end of the seam pressure frame is joined to an upper surface of the seam pressure roller holding part 66. The seam pressure roller support 68 has substantially the same length as both ends of the base material 20 in the longitudinal direction, and the side surfaces of the pressure rollers 30A and 30B and the seam pressure roller support 68 are supported at a position corresponding to the load point P. Each of the members may be screwed. Further, if the seam pressure roller holding part 66 and the seam pressure roller support 68 are detachably provided, it is possible to perform adjustment according to the position of the load point P.

The seam pressure roller holding part 66 holds two pressure rollers 30A and 30B, which are used for seam welding, by holding the connection member 68C that supports the pressure roller 30B and the connection member 68C that supports the pressure roller 30A. The seam pressure frame 64 is moved up and down together with the seam pressure roller holding part 66 as a single body, according to the rotation of the seam pressure rotating body 62. For this reason, if the seam pressure rotating body 62 is rotated clockwise in the drawing by a motor or the like (not shown), the seam pressure frame 64 and the seam pressure roller holding part 66 are moved downward so that the pressure rollers 30A and 30B rotating about the rotation axis by the inclination angle corresponding to the inclination of the inclination member 68B are pressed against the sheet material 26.

Referring to FIG. 7(B), the spot welding pressure unit 70 includes a spot pressure rotating body 72 that is rotatably provided; a spot pressure frame 74 that is mounted on the outer circumference of the spot pressure rotating body 72, is moved up and down according to the rotation of the pressure rotating body, and supports other portions of the spot welding pressure unit 70; a spot pressure roller holding part 76 that is joined to the upper surface of the spot pressure frame 74, and a spot pressure roller support 78 that is moved up and down together with the spot pressure roller holding part 76 as a single body and moves up and down the pressure rollers 30C, 30D, and 30E.

The spot pressure roller support 78 includes a rotating shaft member 78A, an inclination member 78B, and a connection member 78C, like the seam pressure roller support 68. Further, the spot pressure roller holding part 76 includes a flat member 76A that is provided on an upper surface of the spot pressure frame 74, erection members 76B that are erected form the upper surface of the fat member 76A and support a holding member 76C, and the holding member 76C that is moved up and down together with the erection members 76B as a single body and holds the spot pressure roller support 78.

Since the seam pressure roller holding part 66 is positioned on the front side of the holding member 76C of the spot pressure roller holding part 76 in the feeding direction U, the connection member 78C of the spot pressure roller support 78 is shorter than the connection member 68C of the seam pressure roller support 68 in the feeding direction U.

Since being independent of each other as shown in FIGS. 6 and 7, the seam welding pressure unit 60 and the spot welding pressure unit 70 are operated without interference and are disposed not to obstruct the drive of the laser mechanism.

Referring to FIG. 8, the gap control device includes independent gas nozzles 44A, 44B, 44C, 44D, and 44E that are provided at two positions to be seam welded and three positions to be spot welded.

FIG. 9(A) shows a cross-section of a non-defective product. Even though some dirt is caught by the gap, penetration welding is performed and a high sealing property is secured. FIG. 9(B) shows a cross-section of a defective product manufactured in the related art. There is underfill (recess of a bead), and nonpenetration welding is performed.

### *1.3. Effect of Details of Gap Control Device

The gap control device shown in FIGS. 6 to 8 has a mechanism that makes the seam welding pressure unit 60 and the spot welding pressure unit 70 be independent of each other and performs pressing by the seam pressure frame 64 or the spot pressure frame 74. Accordingly, it is possible to manufacture a silencer of a muffler by two welding torches 80 at high speed and high quality while securing the moving spaces of two laser mechanisms 10. Further, if the positional relationship between the load point P and the focusing position S (laser irradiation point) is controlled when welding is performed by the pressure wheels 30A and 30B while the welding gap t is corrected, it is possible to provide welding means that geometrically forms a required welding gap t at the sheet material 26 (upper plate) and the base material 20 or the wound sheet material 26 dower plate), and performs welding.

Since the circle of the pressure roller 30 and the circle of the base material 20 come in contact with each other while being rotated, it is possible to obtain a silencer of a muffler having high roundness (shape accuracy) as a secondary effect.

Further, since a basic logic controlling the gap is achieved by the controller of the welding torch 80, it is possible to move the welding torch 80 to an optimum irradiation point according to the shape of a work (difference in diameter).

### 1.4. Folding Pressure Welding

An example, where this embodiment is applied to the lap welding used for not the winding of the sheet material 26 but an edge (flange), will be described below. In this example (folding pressure welding), one edge is folded and the folded portion is pressed by a pressure roller 30 so as to be flat while a welding gap t is secured during the irradiation of the laser beam B. An object (lower part) that is not folded is referred to as a base material 20, and the edge of the base material 20 is referred to as a base material face 21. Further, the edge of the lapped upper part 25 is referred to as a folded face 27. The folded face 27 is folded at the edge of the upper part 25, which is lapped over the base material face 21, in a direction substantially orthogonal to the welding direction.

In the examples shown in FIGS. 10 and 11, a gap holding unit 12 includes a base material support 24, and a folded face guide 29 that includes an adjustment roller 45.

The base material support 24 supports the base material 20 (lower part) having the base material face 21 that is one object. The folded face guide 29 guides the folded face 27 of the upper part 25 toward the base material face 21, and forms the welding gap t.

Further, the pressure unit 14 includes a pressure roller 30 and a pressing roller 46.

The pressing roller 46 supports the folded face 27 and the base material face 21, which is an edge, on the lower side by pressing the base material face 21 from the side opposite to the laser mechanism 10. After the laser beam B guided by the folded face guide 29 is irradiated, the folded face 27 is interposed between the pressure roller 30 and the pressing roller 46 at the load point P, which is distant by the focusing load point distance x, and is pressed.

The edge of the upper part 25 is previously folded as shown in FIG. 10, so that a gap is formed between the edge of the upper part and the base material face 21 of the base material 20 that is the lower part. The folded edge is guided by the adjustment roller 45 so that the gap formed by folding the edge of the upper part becomes a predetermined welding gap t. Further, as shown in FIG. 11, at a portion when the folded face 27 is folded, a tension roller 40 may guide the folded face 27 as a part 29A of the folded face guide 29.

As shown in FIG. 11, the pressing at the load point P is performed between the pressing roller 46 and the pressure roller 30. The focusing load point distance x is a value that is obtained by adding x₁ to x₂ in the drawing. In the example shown in FIG. 1, the opening direction from the load point P toward the welding gap t is the same direction as the welding direction. However, in the folding pressure welding shown in FIGS. 10 and 11, the opening direction formed by folding the folded face 27 is a direction orthogonal to the welding direction. In this respect, in the examples shown in FIGS. 10 and 11, the adjustment roller 45 is disposed close to the side surface of the upper part 25, and the pressure roller 30 is disposed outside the upper part so as to be deviated by x2. Accordingly, when FIG. 3(B) is compared with the adjustment of the gap along the circumference of the welding radius R2, the welding gap t is controlled in two dimensions along the outer circumference of a sphere of the welding radius R in the folding pressure welding. That is, galvanizing or shielding gas is released in the welding direction and is also released in a direction orthogonal to the welding direction. Further, due to this disposition, the folded face 27 is lapped from the side surface of the upper part toward the base material face 21, and may be lapped so that a gap is completely removed at the load point P of the pressure roller 30.

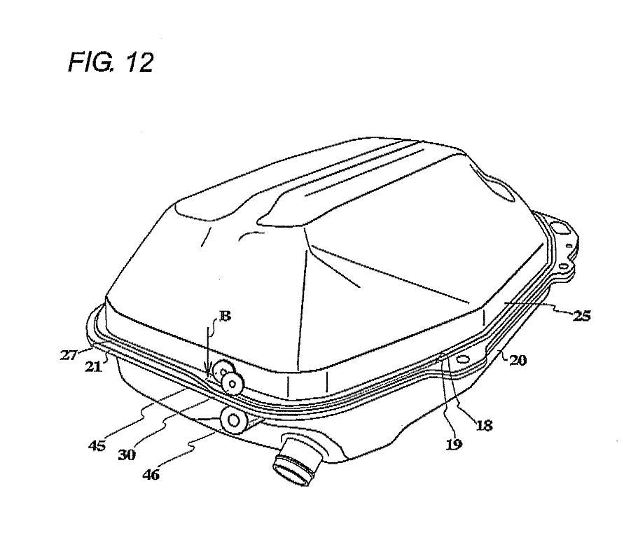

FIG. 12 is a perspective view showing an example where the folding pressure welding is applied to a fuel tank used for a movable object such as an automobile. The fuel tank is manufactured by lapping the upper part 25 over the base material 20 that is a lower part, and performing lap welding at the folded face 27 and the base material face 21 forming an edge. Since a product is the fuel tank, the sealing property of the laser welding is important. In the example shown in FIG. 12, welding is performed from the right inner side in the drawing, the laser beam B is irradiated up to the position of the laser beam B in the drawing, and pressing at the load point P is completed, so that the weld beads 18 and the pressed indents 19 are formed. In addition, welding is performed toward the left side in the drawing.

Relative movement in the welding direction may be achieved by moving the fuel tank while the positions of the laser mechanism 10 and the pressure roller 30 are fixed, the laser mechanism 10 may be moved as a unit, and both the fuel tank and the laser mechanism may be moved. Simultaneously moving the fuel tank and the laser mechanism is, for example, a method that a linear portion is welded while the laser mechanism 10 is driven and a nonlinear portion is welded while the fuel tank is rotated. Further, the adjustment roller 45 and the pressing roller 46 are provided with spheres that are pressed against the side surface of an object and are rotated according to relative movement, and the spheres may be used to determine the relative position.

### *1.4. Effect of Folding Pressure Welding

As described above, one edge having been lapped is previously folded, the gap holding unit 12 guides the edge so that the gap formed by folding the edge becomes a welding gap t at the focusing position S, and the pressure roller 30 presses the folded face 27 so that the welding gap t is sequentially decreased and is removed at the load point P. Accordingly, it is possible to improve a sealing property, and to secure stiffness and strength without distortion. Further, it is possible to stably manufacture a product, which is not different from design strength or the supposition of behavior (for example, results of simulation using a finite element method or the like), at high yield.

### Second Embodiment

### 2.1. Laser Lap Welding Method

The second embodiment is a method of manufacturing various products by lap laser welding using the gap control device according to the first embodiment.

As shown in FIG. 13, in a laser lap welding method, first, objects are lapped while a predetermined welding gap t is formed at a part or all of the focusing position S of the laser beams B in the irradiation direction of the laser beam B (Step S1). In the example shown in FIG. 1(A), the sheet material 26 is lapped over the base material 20. In the example shown in FIG. 10, the folded face 27 is lapped over the base material face 21.

Then, shielding gas is injected toward the focusing position S, and the laser beam B begins to be irradiated (Step S2). A keyhole 16 is formed at the object by the irradiation of the laser beam B, and a melted portion penetrates the object.

Subsequently, the relative positions of the object and the focusing position S are moved so that the laser beam B travels in the welding direction (Step S3). For example, in the example shown in FIG. 1(A), the stopped laser beam B relatively travels in the welding direction by rotating the base material 20 clockwise in the drawing. Further, when the relative positions are moved, the lapped surfaces of the sheet material and the base material are pressed at the load point P that is distant from the focusing position S in the welding direction by the focusing load point distance x (Step S4). Furthermore, the relative positions travel to the other end of a weld line, so that seam welding is performed on the sheet material and the base material (Step S5).

### *2.1. Effect of Laser Lap Welding

It is possible to manufacture a cylindrical member (FIGS. 1(A) and 5(A) to 5(D)), a plate (FIG. 1(B)), a muffler silencer (FIG. 6 and the like), a container (FIG. 10 and the like), and a fuel tank (FIG. 12) by the laser lap welding. It is possible to stably and particularly improve the sealing property of each product by suppressing poor welding. Further, since solidification is performed after pressing is performed by the pressure roller, it is possible to stably secure appearance and strength that satisfy design requirements. In addition, it is possible to obtain manufactures, which is very similar to the estimation such as previous simulation, by penetration welding and continuous pressing at the load point that is relatively displaced.

### 2.2. Winding Welding Method

The lap welding is very effective in the winding welding of a sheet material.

Referring to FIGS. 5(A) to 5(D) and 13 again, the sheet material 26 is lapped over the outer circumference of the cylindrical base material 20 as shown in FIG. 5(A) (Step S1). After that, when the relative position is moved, the base material 20 is rotated about the rotation axis 22 of the cylindrical base material 20 as shown in FIG. 5(B) (Step S2). In addition, as shown in FIG. 5(C), the sheet material is wound around the base material predetermined times by the lapping of the sheet material 26 and the rotation of the base material 20 (Steps S3 to S5). Further, as shown in FIG. 5(D), at the end of the weld line, spot welding is performed at the weld spots 54 of the base material and the sheet material wound around the base material at the end 52A of the sheet material 26 in a direction parallel to the rotation axis (Step 66).

### *2.1. Effect of Laser Winding Welding

In the laser winding welding shown in FIGS. 5(A) to 5(D) and 13, it is possible to obtain the above-mentioned various effects. In particular, if pressing is performed by the rotation of the base material 20 and the rotation of the pressure roller 30 while weld quality is secured, it is possible to obtain good appearance of a product.

While the present invention has been shown and described with reference to certain exemplary embodiments thereof, it will be understood by those skilled in the art that various changes in form and details may be made therein without departing from the spirit and scope of the invention as defined by the appended claims.

1. A gap control device configured for use with a laser welding device adapted to weld objects to each other, the gap control device comprising:
a laser guide, configured to guide a laser beam to a focusing position;
a gap holder, configured to feed the objects in a feeding direction toward the focusing position and to form a predetermined gap between the objects at at least a part of the focusing position; and
a press, configured to press the object materials at a pressing position which is distant from the focusing position by a predetermined distance in the feeding direction.

2. The gap control device as set forth in claim 1,
wherein the gap holder includes a first support configured to rotate a base which is one of the objects about a rotation axis of the base in the feeding direction and a second support configured to laminate a sheet which is another of the objects on an outer circumference of the base, and
wherein the press includes a pressing roller configured to be rotated so as to follow the rotated base and a pressing frame configured to rotatably support the pressing roller and to press an outer circumference of the pressing roller toward the pressing position.

3. The gap control device as set forth in claim 1,
wherein the gap holder includes a gap gauge disposed between a base which is one of the objects and a sheet which is another of the objects in front of the focusing position in the feeding direction and configured to form the predetermined gap between the base and the sheet, and
wherein the press includes a pressing roller configured to be rotated so as to follow the fed sheet and a pressing frame configured to rotatably support the pressing roller and to press an outer circumference of the pressing roller toward the pressing position.

4. The gap control device as set forth in claim 1,
wherein the gap holder includes:
a support configured to support a base which is one of the objects and has a first surface; and
a component guide configured to guide a component which is another of the objects and has a second surface which is preliminarily folded to form a preliminary gap between the first surface and the second surface and to press the component to the base to adjust the preliminary gap between the first surface and the second surface to the predetermined gap at the focusing position;
wherein the press includes a first pressing roller and a second pressing roller pressing the base and the component therebetween at the pressing position.

5. The gap control device as set forth in claim 1, wherein the predetermined distance is preliminarily set in accordance with a feeding speed of the objects.

6. The gap control device as set forth claim 1, wherein the predetermined distance is preliminarily set so that the objects are fed from the focusing position to the pressing position for 0.1 second.

7. The gap control device as set forth in claim 1, wherein when one of the objects is fed along a straight line and another of the objects is fed along an arc from the focusing position to the pressing position, a relationship between the predetermined distance and the predetermined gap is preliminarily set in accordance with a curvature radius of the arc.

8. The gap control device as set forth in claim 7, wherein the relationship satisfies the following equation:
t=R−(R²−x²)⁻²
where t is the predetermined gap, x is the predetermined distance and R is the curvature radius of the arc.

9. A laser lap welding method for welding objects to each other, comprising:
forming a predetermined gap between the objects at at least a part of a focusing position;
injecting shielding gas toward the focusing position;
irradiating a laser beam to the focusing position;
feeding the objects relative to the focusing position so that the laser beam proceeds in a direction opposite to a feeding direction of the objects;
pressing the objects at a pressing position which is distant from the focusing position by a predetermined distance in the feeding direction; and
proceeding with the laser beam relative to the objects to the end thereby seam welding the objects to each other.

10. The laser lap welding method as set forth in claim 9,
wherein one of the objects is a base and another of the objects is a sheet;
wherein the sheet is laminated on an outer circumference of the base with a gap therebetween at the focusing position in the forming;
wherein the base is rotated about an rotation axis of the base in the feeding;
wherein the sheet is wound around the base predetermined times in the proceeding; and
wherein the laser welding method further comprising spot welding an end portion of the sheet in the feeding direction.
